(19) United States
(12) Patent Application Publication
(10) Pub. No.: US 2003/0180135 A1
(43) Pub. Date: Sep. 25, 2003

(54) Adjustable end arm effector

(76) Inventors: Edwin G. Sawdon, St. Clair, MI (US); Stephen E. Sawdon, Marysville, MI (US); Dean J. Kruger, Jeddo, MI (US)

Correspondence Address: HARNESS, DICKEY & PIERCE, P.L.C., P.O. BOX 828, BLOOMFIELD HILLS, MI, 48303, US

(21) Appl. No.: 10/105,880

(22) Filed: Mar. 25, 2002

(51) Int. Cl. B66C 1/00

(52) U.S. Cl. 414/730

(57) ABSTRACT

An adjustable end arm effector joint is provided. The joint includes a first surface having an alignment indicia associated therewith. Another aspect of the present invention includes a second surface having a cooperating alignment indicia associated therewith. The alignment indicia cooperate with each other to identify an alignment position of the mating joint surfaces.

### BACKGROUND AND SUMMARY OF THE INVENTION

The present invention generally relates to end arm effectors usable with industrial robots, and more particularly, to adjustment mechanisms of such end arm effectors.

In general, industrial robots include an articulated arm which is controlled by programming. The articulated arm of the robot typically ends in a support. An end arm effector is attached to the support which is used to hold a workpiece interfacing tool. At the other end, the end arm is generally connected to a base which is used to attach the end arm to the articulated arm.

End arm effectors can include adjustable elements. For example, a workpiece interfacing tool may be attached to an end arm in utilizing an adjustment mechanism such that the rotation, angle and/or location of the tool with respect to an arm may be modified. Less commonly, the rotation, angle and/or length of a particular end arm may be adjustable relative to its base or attachment point to the articulated arm.

Examples of adjustable end arm effectors are disclosed in the following U.S. Pat. Nos.: 5,383,738 entitled “Ball Jointed Links” which issued to Herbermann on Jan. 24, 1995; 5,135,276 entitled “Transfer Boom” which issued to Blatt et al. on Aug. 4, 1992; and 5,071,309 entitled “Mounting Arrangement for a Multi-Function Arm” which issued to Herbermann on Dec. 10, 1991 and in U.S. patent application Ser. No. 09/006,248 filed on Jan. 13, 1998, all of which are incorporated by reference herein.

Utilizing adjustable end arm effectors can offer significant advantages. For example, the need to fabricate an end arm effector for each specific application is eliminated. Instead, the components from an adjustable end arm effector can simply be readjusted for use in another application. This can save considerable time and money in comparison to the traditional fixed end arm effector manufacturing process.

To utilize adjustable end arm effectors, however, the appropriate adjustments must be made during a set-up process. This may be done, for example, initially or after an industrial robot crash which impacts the adjustments. In one known set-up process a master workpiece is located on the load or unload fixture. The industrial robot is located in the work position with respect to the workpiece. Then, appropriate adjustments are made to the various end arm effectors that interact with the workpiece. One disadvantage of this set-up process is the requirement that when multiple adjustable arm end arm effectors are utilized, all of the arms are adjusted at one time while the robot remains in one position. Another disadvantage is the amount of space that can be required and the difficulty managing the master workpiece part, particularly when the workpieces are large sheet metal components.

In accordance with the present invention, an adjustable end arm effector joint is provided. The joint includes a first surface having an alignment indicia associated therewith. Another aspect of the present invention includes a second surface having a cooperating alignment indicia associated therewith. The alignment indicia cooperate with each other to identify an alignment position of the mating joint surfaces. In a further aspect of the present invention, the joint additionally includes a friction engagement mechanism to frictionally engage and selectively maintain the alignment position of mating joint surfaces relative to each other. In an additional aspect of the present invention, a process for aiding the set-up of an adjustable end arm effector is provided. In yet another aspect of the present invention, a process for aiding the set-up of a compound joint of an adjustable end arm effector is provided.

This case exemplifies that “indicia” as used herein includes any feature which is capable of cooperating with another feature (e.g., cooperating indicia) to enable the visual or tactile identification of an alignment position relative to two components. Preferably, however, the indicia enables visual identification of the alignment position. More preferably, the indicia and cooperating indicia are markings on the respective components (rather than simply an edge of a component) enabling visual identification of the alignment position.

Further areas of applicability of the present invention will become apparent from the detailed description provided hereinafter. It should be understood that the detailed description and specific examples, while indicating preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an elevational view of an adjustable end arm effector of the present invention shown attached to an industrial robot;

FIG. 2 is a perspective view of the adjustable end arm effector of FIG. 1;

FIG. 3 is a cross sectional view, taken along line 3-3 of FIG. 2, illustrating a compound joint having three joints allowing movement in different planes; and

FIG. 4 is an enlarged, exploded perspective view of a portion of the compound joint at the far left of FIG. 2.

### DESCRIPTION OF THE PREFERRED EMBODIMENT

The following description of the preferred embodiment(s) is merely exemplary in nature and is in no way intended to limit the invention, its application, or uses. For example, although the invention is described throughout with respect to an industrial robot, any controlled manipulation may be utilized, including manual manipulation.

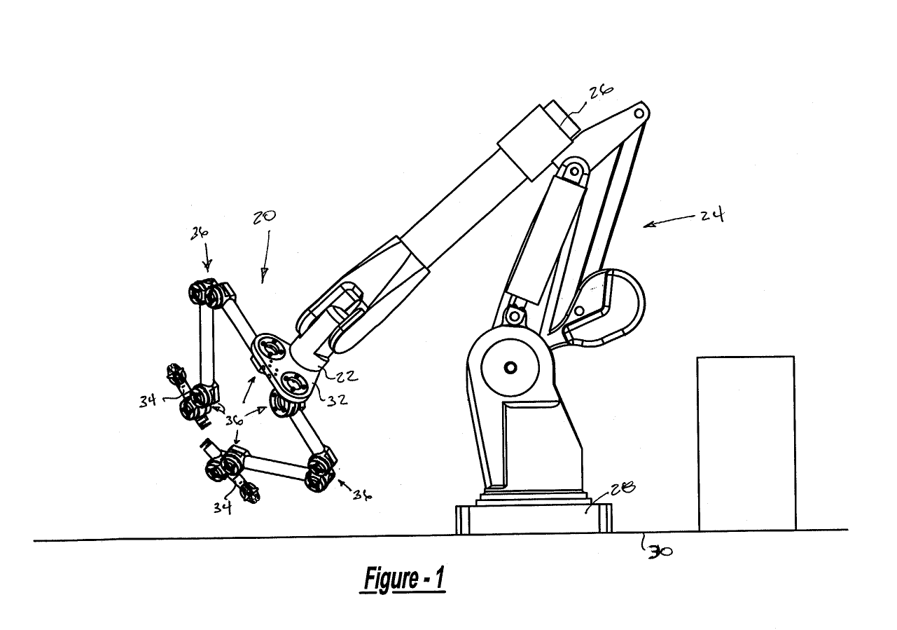

Referring to FIG. 1, a preferred embodiment of a two arm end arm effector of the present invention, indicated generally as 20, is illustrated mounted onto the working end 22 of an industrial robot 24. The industrial robot includes an articulated arm 26. The articulated arm 26 is rotatably attached to a pedestal 28 which is in turn attached to the factory floor 30. The articulated arm 26 includes a working end 22 which is movable relative to the pedestal 28. The two arm end arm effector 20 of this embodiment includes a support plate or base 32 which is attached to the working end 22 of the industrial robot 24.

This adjustable two arm end arm effector 20 includes workpiece interfacing tools 34. As illustrated, the tools 34 are pneumatically powered grippers, as that disclosed in U.S. Pat. No. 5,647,625 entitled “Gripper” which issued to Sawdon on Jul. 15, 1997, and is incorporated by reference herein. However, in order for tools 34 to interface correctly with a workpiece 33, end arm effector 20 must be set-up by appropriate adjustment. If the end arm effector 20 is not appropriately adjusted, then robot 24 will not be able to interface correctly with the workpiece to move it from one manufacturing station to another or to hold it during welding, for example. The end arm effector 20 includes various indicia to be used as an aid in adjusting the various joints as discussed hereinafter to enable appropriate set-up.

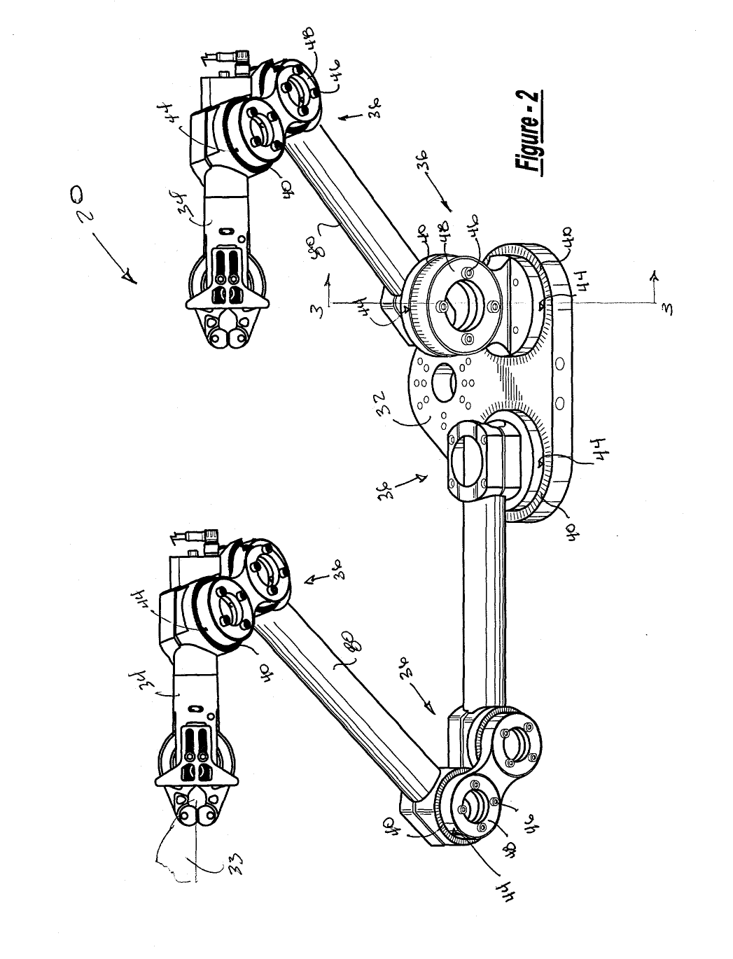

Each arm of the two arm end arm effector 20 includes a plurality of compound joints 36 and each such joint 36 permits varying degrees of adjustability. As will be identified and described more fully hereinafter and as seen in FIG. 2, each compound joint 36 includes unidirectional joints comprising a first member with alignment indicia 40 thereon, a second member having cooperating alignment indicia 44, and a friction engagement mechanism (including, for example, threaded bolts 46 and annular members 48). Each joint may alternatively be described as generally including a first surface having alignment indicia 40 associated therewith, a second surface having cooperating alignment indicia 44 associated therewith and a friction engagement mechanism as described hereinafter.

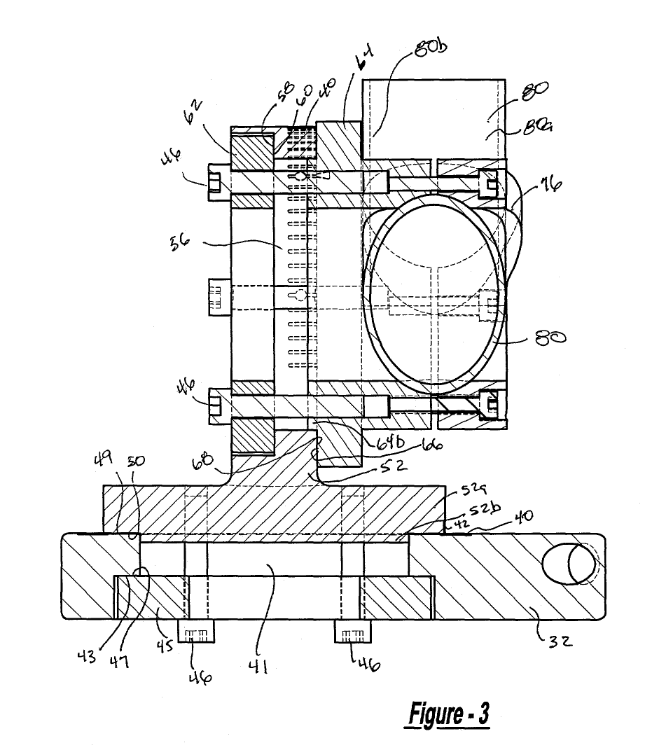

Referring to FIG. 3, more detail is provided with respect to a joint 36a located at the right side of support plate 32 as seen in FIG. 2. Support plate 32 is operating as the first member and includes an aperture 41 having a large diameter portion and a smaller diameter portion providing a stepped inner surface. This construction provides an annular engagement surface 43 against which an annular member 45 having a cooperating annular engagement surface 47 can frictionally engage, operating as part of the friction engagement mechanism. Support plate 32 also includes a planar surface 49 on its upper side operating as a first surface, parallel to and opposite of annular engagement surface 43 of aperture 41.

A cooperating planar surface 50 operates as a first cooperating surface and is located against this upper planar surface 49. A perpendicular support member 52 operates as the second member of this joint. Annular member 45 and threaded bolts 46 also operate as part of the frictional engagement mechanism. Thus, the first surface, in this case 49, and the first cooperating surface, in this case 50, are frictionally engaged against each other. Although as described and illustrated herein, these surfaces are located directly against each other, they may alternatively be placed indirectly against each other. For example, an intermediate part may be included between these two surfaces. As used herein, use of the language “against each other” is inclusive of directly or indirectly locating the parts against each other. Preferably, however, “against each other” means the parts are directly located against each other. In any case, for example, the parts are capable of being frictionally engaged with respect to each other.

Also as illustrated, there are preferably no teeth or segments which require the first surface 49 to be located into specific orientations with respect to the first cooperating surface 50. Thus, the cooperating surfaces, in this case 49 and 50, are preferably infinitely radially adjustable relative to each other so that they may be locked into any alignment position by the engagement mechanism.

Perpendicular support member 52 has a circular plate portion 52a which includes a protruding guide portion 52b. Protruding guide portion 52b cooperates with the smaller diameter portion of aperture 41 to position and maintain perpendicular plane member 52 in place. Thus, support plate 32 and perpendicular support member 52 can selectively rotate with respect to each other about an axis running through the aperture 41, enabling movement in a first plane perpendicular to the axis.

Threaded bolts 46 are provided to pull the annular member 45 toward the perpendicular support member 52. As the threaded bolts 46 are tightened, a compressive force is provided on the oppositely disposed engagement surfaces 43 and 49 of the support member 32 which is sandwiched between opposed engagement surfaces 47 and 50 of the annular member 45 and perpendicular support member 52. Thus, the upper surface 49 of the support member 32 and the lower surface 50 of the perpendicular support member 52 or second joint member and the upper surface 47 of the annular member 45 and the engagement surface 43 of the support member 32 are all selectively forced into frictional engagement or selectively allowed to move relative to each other by loosening the threaded bolts 46.

The components must be appropriately positioned for accurate set-up prior to frictionally engaging these components relative to each other by tightening the threaded bolts 46. To aid the set-up process, indicia 40 is provided on the upper surface of the support member 32 and cooperating indicia 42 is provided on the surface adjacent the lower surface 50 of the perpendicular support member 52. In this case, the indicia 40 on the upper surface 49 of the support member 32 is a series of marks associated with angular degrees. The cooperating indicia 42 on the perpendicular support member 52 is a single alignment mark which cooperates with the degree marks to indicate various degrees and enable identification of an alignment position.

Many alternative constructions are possible with respect to this joint. For example, one or more of the sets of cooperating engagement surfaces 43 and 47 or 49 and 50 could be conically (or spherically) shaped rather than the stepped aperture 41 structure using planar and parallel sets of surfaces. Such constructions might also provide the centering function, thereby eliminating the need for the protruding guide portion 52b.

The perpendicular support member 52 is a single, integral component including parts of two separate joints which enable angular movement in two separate planes which are perpendicular to each other, thereby creating a compound joint permitting movement in two perpendicular planes. This second joint located at its upper end includes a construction quite similar to the first.

The upper portion of the perpendicular support member 52 operating as the first joint member including an aperture 56 with larger diameter and smaller diameter segments, thereby providing a planar annular engagement surface 58. As before, a cooperating annular engagement surface 60 is provided by an annular member 62 operating as part of the friction engagement mechanism. This joint also includes a rotary tubular support member 64 operating as the second joint member for this joint. From the viewpoint of the controlled joint, including this joint and the joint previously described, the support member 32 is operating as a third joint member.

The rotary tubular support member 64 includes a protruding guide portion 64b and a planar engagement surface which cooperates with a similar planar engagement surface 66 on the upper portion of the perpendicular support member 52. As previously described, threaded screws 46 provide a compressive force between the sets of engagement surfaces 58 and 60, 66 and 68 for selectively locking the members in a selected alignment position relative to each other. Thus, the perpendicular support member 52 includes an engagement surface 50 of a first joint associated with movement in one plane and an engagement surface 68 of a second joint associated with movement in a plane perpendicular to the first plane.

Again, indicia 40 indicating the various angle marks is included on a surface adjacent the planar surface 68 of the perpendicular support member 52. The cooperating indicia 42 alignment mark is located on the adjacent surface to the cooperating planar surface 66 of the rotary tubular support member 64.

All of the above discussed indicia marks 40, 42 are the result of forming recesses in the surfaces of the associated member. Alternatively, the indicia marks could be a result of providing protrusions or painted markings on the surfaces of the associated member. Although providing a single cooperating indicia mark on each cooperating member is possible, it is preferred that at least one of the cooperating indicia marks 40, 42 includes a plurality of marks as illustrated to provide guidance regarding selectively locating and locking the joint in a plurality of possible orientations. The indicia marks 40, 42 are also preferably formed using material which is essentially identical to the material of the surface and/or essentially permanently bonded to the member rather than the mere surface application of a dissimilar and non-permanently bonded material such as paint which is not durable and accurate over time in the typical rugged manufacturing plant environment. Thus, the indicia is preferably provided on the member in a substantially permanent state.

Many modifications may be made to the joints described herein. For example, one or more of the frictional engagement surfaces of a joint may alternatively be provided with a rough surface to enhance frictional engagement; for example, knurl or serration patterns can be employed. Another possible modification extends the recesses into the frictional engagement area and protrusions may additionally be provided on the bottom frictional engagement surface. The protrusions mate with at least one of the recesses to provide a detent locking feature, again enhancing the frictional engagement as well as discrete positioning.

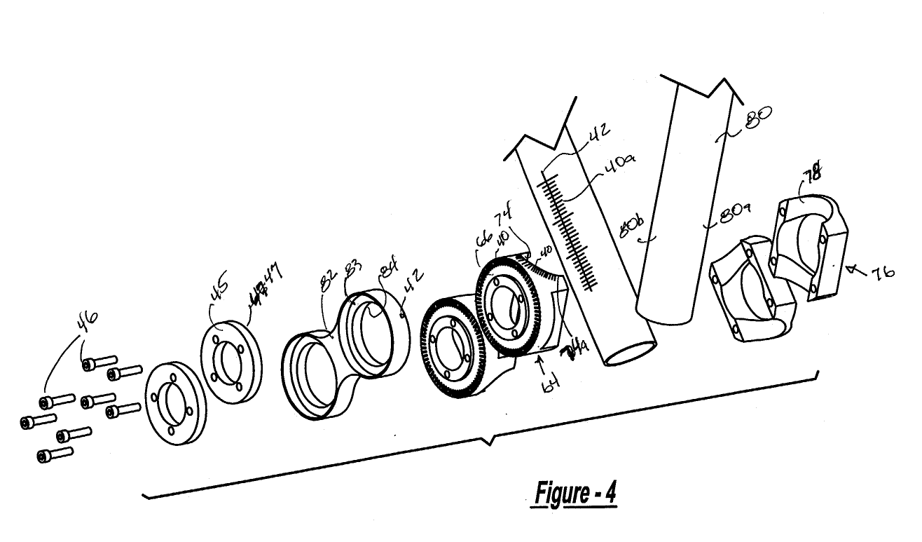

A third adjustable joint is also illustrated in the cross sectional view of FIG. 3. This joint is formed from the left portion of the rotary tubular support member 64 which provides an engagement surface 74 (such as is seen in FIG. 4) corresponding to the engagement surface 50 provided by the perpendicular support member 52 of the first joint described herein. This joint also includes a tubular support member 76 having a engagement surface 76 which corresponds to the previously described cooperating annular engagement surface 47 of the annular member 45. Additionally, the joint includes a tubular member 80 having an outer surface with left 80b and right 80a halves which correspond to the upper 49 and lower 43 engagement surfaces of the support member 32 as first described herein. Tubular member 80 is circular in cross-section, although it appears oval due to its being sectioned at an angle in FIG. 3. This adjustable joint permits longitudinal adjustments by permitting selective movement of the tubular member 80 lengthwise up or down and permits angular adjustments by rotation of the tubular member 80 with respect to the lower tubular support member 64 and the tubular support member 76. Furthermore, the rotary tubular support member 64 is a single, integral component which provides engagement surfaces for more than one joint, enabling compound adjustment. The indicia for this joint is identical to that described below with respect to FIG. 4.

As seen in FIG. 2, the compound joint 36 at the support base 32 for the left arm of the end arm effector 20 compound joint which is essentially the same as the two previously described joints, so it will not be described in detail again. The only difference is instead of having a perpendicular support member 52, the rotary tubular support member 64 directly contacts against the surface plate 32.

Referring now to FIG. 4, the intermediate compound joint is essentially the same as the two previously described joints. Instead of using a perpendicular support member 52 or the support plate 32, however, a dual support member 82 is utilized. The dual support member 82 has opposing engagement surfaces 83, 84 which are compressed between an engagement surface 66 of a rotary tubular support member 64 and an annular surface 47 of an annular member 45 which acts as a part of the frictional engagement component. The dual support member 82 provides a pair of engagement surfaces for two joints, allowing rotational movement about two axis perpendicular to a single plane. The indicia with respect to this joint is similar to that which has been previously described. However, the indicia 40 associated with surface 66 is on the same surface, and is the multiple angle marks. Thus, the indicia 42 associated with surface 84 is on an adjacent surface and is the single alignment mark.

The joint at the right side of FIG. 4, which allows rotary and longitudinal movement of the tubular member 80, is identical to the upper left side joint discussed above with respect to FIG. 3. This joint includes a rotary tubular support member 64 having a semi-circular engagement surface 74. A tubular support member 76 having a similar semi-circular engagement surface 78, and a tubular member 80 with an outer surface having two halves 80a, 80bwhich provide cooperating engagement surfaces.

The rotary tubular support member 14 includes indicia 40 representing angular marks on the surface adjacent the engagement surface 74. A longitudinal line of coordinating indicia 42 extends down the tubular member which cooperates with the angular marking indicia 40 to identify various angular positions. In addition, a series of transverse lines 40a which cooperate with the edge 74a of the engagement surface 74 to identify various longitudinal positions with respect to the joint members. Thus, in this case, one of the cooperating indicia elements is provided by the edge 74 of the surface.

This illustrated cooperating indicia 40a, 74a exemplifies that “indicia” as used herein includes any feature which is capable of cooperating with another feather (e.g., cooperating indicia) to enable the visual or tactile identification of an alignment position relative to two components. Preferably, however, the indicia enables visual identification of the alignment position. More preferably, the indicia and cooperating indicia are markings on the respective components (rather than simply an edge of a component) enabling visual identification of the alignment position.

Referring to FIG. 2, the workpiece interfacing tools are illustrated as grippers 44 and are attached utilizing components 45, 46, 82, 64 and 76 as previously described. For example, attached to the end of the tubular members 80 are tubular support members 76, a rotary tubular support member 6f4 and an annular member 45. A cylindrical, exterior body surface of gripper 34 is held similar to the tubular support member 80 of the adjacent uni-directional joint using a rotary tubular support member 64 and a tubular support member 76.

One particularly advantageous feature of this preferred embodiment is the ability to route pneumatic tubes to the gripper 34 through the interior of the tube members 80 of the end arm effector 20. For example, a manifold in the base 32 is used to provide communication through pneumatic tubes to the gripper 34. The pneumatic tube runs from a manifold in the base 32 to the gripper 34 through the various tube members 80. thus, the possibility of pneumatic tubes catching on the workpiece 33 is dramatically reduced.

Another aspect of the present invention involves a process aiding the set-up of an adjustable end arm effector 20. For example, the process involves providing an adjustable end arm effector 20 which includes alignment indicia 40, 42 such as previously described herein. By utilizing indicia 40, 42, an adjustable end arm effector 20 may be set-up, for example, initially, or after undesired movement such as a forklift truck or the like crashing into and moving an arm of the effector. Thus, the process involves identifying a desired alignment position of the first and second surfaces relative to each other correlated to the alignment indicia.

In one variation, mathematical calculations are used to calculate the desired alignment position. The calculation preferably calculates the alignment position in terms of the alignment indicia 40 and the cooperating alignment indicia 42. Alternatively, the results of the calculation are converted to correlate with the indicia 40, 42. Once the calculation is done, the indicia 40, 42 is utilized to locate the end arm effector 20 in the appropriate position by placing the alignment indicia 40 and cooperating alignment indicia 42 in the calculated position relative to each other. Thus, the adjustable end arm effector 20 is appropriately adjusted and properly set-up.

Alternatively, the adjustable end arm effector 20 is initially set up. Then the indicia 40, 42 is utilized to read off and record the correct position of the alignment indicia 40 relative to the cooperating alignment indicia 42. This recorded information is then subsequently used to set up the adjustable end arm effector 20, e.g., if the adjustable end arm effector 20 crashes or is moved. Where multiple identical adjustable end arm effectors 20 are being created, for example, the recorded information from one previously set-up adjustable end arm effector 20 is utilized in an initial (or subsequent) set-up process for another, but identical adjustable end arm effector 20.

As exemplified above in the discussion related to FIGS. 1-4, many of the joints 36 in an adjustable end arm effector 20 are actually compound joints involving multiple joints offering adjustability in various directions. Each joint has alignment indicia 40 and cooperating alignment indicia 42 associated with it. Thus, the set-up process includes utilizing multiple sets of indicia 40, 42 associated with an adjustable end arm effector 20, an adjustable end arm effector arm and/or a compound joint 36 of an adjustable end arm effector 20.

Only a few of the many possible alternatives which may be useful in the adjustable end arm effector of the present invention or process of the present invention are described above. Furthermore, use of terms such as first or second herein, including the claims, are simply utilized to distinguish between two commonly named features and do not imply importance, positioning, etc.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An adjustable end arm effector joint comprising:
a first surface having a first alignment indicia associated with said first surface;
a second surface having a second alignment indicia associated with said second surface, said first surface and said second surface being coupled together between said first and second alignment indicia and being positioned to identify an alignment position of the first and second surfaces relative to each other; and
an engagement mechanism operatively associated with said first surface and said second surface to frictionally engage the first surface and said second surface against each other to selectively maintain the alignment position of the first and second surfaces relative to each other.

2. An adjustable end arm effector joint according to claim 1, wherein the alignment indicia includes a series of indicia representing angle positions and wherein the cooperating indicia is a single alignment indicia which cooperates with the angle indicia to identify various angles.

3. An adjustable end arm effector joint according to claim 2, wherein at least one of the alignment indicia and the cooperating alignment indicia is recessed into an associated surface which is selectively movable with respect to the first surface or the second surface.

4. An adjustable end arm effector joint according to claim 1, further comprising a workpiece interfacing tool coupled to said joint.

5. An adjustable end arm effector joint according to claim 4, wherein said workpiece interfacing tool is an automatically powered gripper.

6. An adjustable end arm effector joint according to claim 1, wherein each of said first surface and said second surface are planar.

7. An adjustable end arm effector joint according to claim 1, wherein the alignment indicia is located on the first surface, and the cooperating alignment indicia is located on a surface adjacent to the second surface.

8. An adjustable end arm effector joint according to claim 1, wherein the alignment indicia is located on a surface adjacent the first surface, and the cooperating alignment indicia is located on a surface adjacent to the second surface.

9. An adjustable end arm effector joint according to claim 1, wherein the alignment indicia is recessed into a surface associated with the first surface.

10. An adjustable end arm effector joint according to claim 1, further comprising a robot arm coupled to said joint.

11. An adjustable end arm effector joint according to claim 1, wherein said first and second surfaces are infinitely radially adjustable relative to each other into any alignment position.

12. An adjustable end arm effector joint comprising:
a first member having a first surface associated with a first joint and a second surface associated with a second joint, the first surface having an alignment indicia associated with the first surface, and the second surface having an alignment indicia associated with the second surface;
a second member associated with the first joint and a third member associated with the second joint, each of the second and third members having a first cooperating surface and a cooperating alignment indicia associated with said first cooperating surface, said first surface and said first cooperating surface located against each other, said alignment indicia and said cooperating alignment indicia being positioned to cooperate with each other to identify an alignment position;
a friction engagement mechanism operatively associated with each of said first joint and said second joint to frictionally engage the first surface and said first cooperating surface against each other to selectively maintain the alignment position of the first surface and said first cooperating surface relative to each other.

13. An adjustable end arm effector joint according to claim 12, wherein at least one of said alignment indicia includes a series of indicia representing angle positions and wherein the cooperating indicia is a single alignment indicia which cooperates with said at least one said angle indicia to identify various angles.

14. An adjustable end arm effector joint according to claim 13, wherein at least one of the alignment indicia and the cooperating alignment indicia is recessed into an associated surface which is selectively movable with respect to the first surface or the second surface.

15. An adjustable end arm effector joint according to claim 12, wherein one of said second member and said third member is directly connected to a workpiece interfacing tool of the adjustable end arm effector.

16. An adjustable end arm effector joint according to claim 15, wherein said workpiece interfacing tool is an automatically powered gripper.

17. An adjustable end arm effector joint according to claim 12, wherein at least one of the alignment indicia is recessed into a surface associated with the first surface.

18. An adjustable end arm effector joint according to claim 12, wherein the first surface and the second surface are in the same plane.

19. An adjustable end arm effector joint according to claim 12, wherein the first surface and the second surface are in parallel planes.

20. An adjustable end arm effector joint according to claim 12, wherein the first surface and the second surface are in planes which are perpendicular to each other.

21. An adjustable end arm effector joint according to claim 12, wherein one of said second member and said third member is directly connected to a base plate of the adjustable end arm effector, the base plate being adapted to be connected to a working end of an industrial robot.

22. An adjustable end arm effector joint according to claim 12, wherein said friction engagement mechanism includes two separate frictional engagement mechanisms, one associated with each of said joints.

23. An adjustable end arm effector joint according to claim 12, wherein at least one of said first surfaces and said first cooperating surface in contacting opposed relationship therewith are planar.

24. An adjustable end arm effector joint according to claim 12, wherein at least one of the first and second surfaces is infinitely radially adjustable relative to the first cooperating surface into any alignment position.

25. A process for aiding the set-up of an adjustable end arm effector comprising:
coupling a first surface, having a first alignment indicia associated with the first surface, to a second surface, having a second alignment indicia associated with the second surface;
aligning the first and second surfaces relative to each other utilizing the indicia; and
securing said first and second surfaces relative to each other to selectively maintain the alignment position of the first and second surfaces relative to each other.

26. A process for aiding the set-up of an adjustable end arm effector according to claim 25, further comprising identifying an alignment position of said first and said second surfaces relative to each other.

27. A process for aiding the set-up of an adjustable end arm effector according to claim 26, wherein the step of identifying an alignment position includes mathematically calculating the alignment position and utilizing the indicia to locate the alignment position.

28. A process for aiding the set-up of an adjustable end arm effector according to claim 27, wherein mathematically calculating the alignment position involves utilizing a mathematical calculation which generates a result in terms of the indicia.

29. A process for aiding the set-up of an adjustable end arm effector according to claim 27, wherein mathematically calculating the alignment position involves utilizing a mathematical calculation which generates a result which is subsequently correlated to the indicia.

30. A process for aiding the set-up of an adjustable end arm effector according to claim 26, wherein the step of identifying an alignment position includes an initial set-up step of adjusting an adjustable end arm effector in relation to a workpiece and recording the alignment position information from the indicia and thereafter utilizing the recorded indicia to appropriately locate the alignment position.

31. A process for aiding the set-up of an adjustable end arm effector according to claim 30, wherein the initial set-up step involves utilizing the recorded indicia information from a first adjustable end arm effector to appropriately locate the alignment position of a second adjustable end arm effector.

32. A process for aiding the set-up of a compound joint of an adjustable end arm effector, the compound joint having at least two unidirectional joints, each joint capable of movement in one direction only, the process comprising:
coupling a first surface having a first alignment indicia associated with the first surface for each unidirectional joint with a second surface having a second alignment indicia associated with the second surface for each uni-directional joint such that said first and second alignment indicia are positioned to cooperate to identify an alignment position of the first and second surfaces relative to each other;
aligning the first and second surfaces relative to each other utilizing the first and second alignment indicia; and
securing said first and second surfaces relative to each other to selectively maintain the alignment position of the first and second surfaces relative to each other.

33. A process for aiding the set-up of an adjustable end arm effector according to claim 32, further comprising identifying an alignment position of said first and said second surfaces relative to each other for each uni-directional joint.

34. A process for aiding the set-up of an adjustable end arm effector according to claim 33, wherein the step of identifying an alignment position for at least one of said uni-directional joints includes mathematically calculating the alignment position and utilizing the indicia to locate the alignment position.

35. A process for aiding the set-up of an adjustable end arm effector according to claim 34, wherein mathematically calculating the alignment position involves utilizing a mathematical calculation which generates a result in terms of the indicia.

36. A process for aiding the set-up of an adjustable end arm effector according to claim 34, wherein mathematically calculating the alignment position involves utilizing a mathematical calculation which generates a result which is subsequently correlated to the indicia.

37. A process for aiding the set-up of an adjustable end arm effector according to claim 33, wherein the step of identifying an alignment position for at least one of said unidirectional joints includes an initial set-up step of adjusting an adjustable end arm effector in relation to a workpiece and recording the alignment position information from the indicia and thereafter utilizing the recorded indicia information to appropriately locate the alignment position.

38. A process for aiding the set-up of an adjustable end arm effector according to claim 35, wherein the initial set-up step involves utilizing the recorded indicia information from a first adjustable end arm effector to appropriately locate the alignment position of a second adjustable end arm effector.

39. An adjustment mechanism useful for maintaining a workpiece interfacing tool comprising:
a first member having a first surface and an opposing second surface, and an aperture through the first member;
a second member having a surface coupled to the first surface;
a third member having a surface coupled to the second surface; and
a compression mechanism passing through the aperture to selectively frictionally engage the first member, the second member and the third member together to prevent relative movement between the members;
a workpiece interfacing tool coupled to one of said first and second members; and
a base coupled to the other of said first and second members.

40. An adjustment mechanism according to claim 39, wherein said base is an industrial robot.

41. An adjustable end arm effector according to claim 40, wherein the workpiece interfacing tool is a fluid powered gripper.

42. An adjustable end arm effector according to claim 39, wherein the workpiece interfacing tool is a fluid powered gripper.

43. An adjustment mechanism according to claim 39, wherein said base is a stationary fixture.

44. An adjustment mechanism according to claim 39, wherein each of the two opposing surfaces are substantially planar.

45. An adjustment mechanism according to claim 39, wherein the compression mechanism includes a plurality of threaded screws.

46. An adjustment mechanism according to claim 39, wherein the second member includes a protrusion which projects partially into said aperture.

47. An adjustment mechanism according to claim 39, wherein the third member is substantially located within a recess of the first member.

48. An adjustment mechanism according to claim 39, wherein at least one of the workpiece interfacing tool and the base is directly coupled to one of said first and second members.

49. An adjustment mechanism according to claim 37, wherein at least one of said second and third members is infinitely radially adjustable into any position relative to the first member.
